(19) United States
(12) Patent Application Publication
(10) Pub. No.: US 2024/0421947 A1
(43) Pub. Date: Dec. 19, 2024

(54) NETWORK SIDE DEVICE AND USER EQUIPMENT IN WIRELESS COMMUNICATION NETWORK

(71) Applicant: NTT DOCOMO, INC., Tokyo (JP)

(72) Inventors: Wenjia Liu, Beijing (CN); Xiaolin Hou, Beijing (CN); Lan Chen, Beijing (CN)

(73) Assignee: NTT DOCOMO, INC., Tokyo (JP)

(21) Appl. No.: 18/700,589

(22) PCT Filed: Oct. 29, 2021
(86) PCT No.: PCT/CN2021/127502

§ 371 Date: Apr. 11, 2024

(51) Int. Cl. H04L 5/00; H04W 72/02

(52) U.S. Cl. CPC H04L 5/0005; H04W 72/02

(57) ABSTRACT

The disclosure provides methods and devices thereof for wireless communication at a network side device and a user equipment (UE). The method includes: receiving information about a first UE; when the first UE is determined to be a first type of UE based on the information, multi-layer coding data for the first UE to obtain a first data stream and a second data stream about the first UE, performing a non-orthogonal multiple-access processing of the first and the second data streams of the first UE with data for a second UE and data for a third UE respectively, to obtain a first preprocessed data and a second preprocessed data, and pre-coding the first preprocessed data and second preprocessed data respectively, wherein the second UE and the third UE are a second type of UE. The method provided in the disclosure removes inter-beam and intra-beam interference and improves system efficiency.

### TECHNICAL FIELD

The present disclosure relates to the field of wireless communications, and more specifically, to a method performed by a network side device in a wireless communication network, a method performed by a user equipment in a wireless communication network, and corresponding network side device and user equipment.

### BACKGROUND

Wireless communication network systems are widely deployed to provide various types of communication content, such as voice, video, packet data, messaging, broadcasting, or the like. These wireless communication network systems are capable of supporting communications with multiple users by sharing available system resources (e.g., time, frequency, and power).

In wireless communication network systems of 5G and beyond 5G, in addition to a traditional terrestrial base station, network side devices such as a High Altitude Platform Station (HAPS), a near-orbit satellite, or the like are proposed to provide services to users. The HAPS, near-orbit satellite, or the like may transmit multiple beams, and each beam may cover a terrestrial cell. There may be one or more user equipments (UEs) in the cell covered by each beam. However, interference may exist among multiple UEs within a geographic coverage area of the same beam, i.e., Intra-Beam interference, and additionally, interference may also exist among multiple UEs within a geographic coverage area of adjacent beams, i.e., Inter-Beam interference.

On the other hand, although in a conventional communication system such as Long Term Evolution (LTE) system, Advanced LTE (LTE-A) system or LTE-A Pro system, various techniques such as code division multiple-access (CDMA), time division multiple-access (TDMA), frequency division multiple-access (FDMA), orthogonal frequency division multiple-access (OFDMA), or discrete Fourier transform spread orthogonal frequency division multiplexing (DFT-S-OFDM), and spatial division multiple-access (SDMA), are proposed to remove the interference among users, the limited antenna configurations and processing capabilities of a HAPS or a near-orbit satellite, along with a large number of users in the coverage area make it is unsuitable for the use of the existing techniques used by traditional terrestrial base stations for the removal of intra-beam interference or inter-beam interference.

As the demand for mobile broadband access continues to increase for more and more UEs, a need exists for further improvements in interference removal techniques.

### SUMMARY

With respect to the above problems, the present disclosure provides a method that may be performed by a network side device and a user equipment in a wireless communication network, whereby the method provided according to the present disclosure may simultaneously consider inter-beam and intra-beam interference and simultaneously remove interference between a first type of user equipment and a second type of user equipment to enhance the overall system efficiency of the wireless communication network, which may simultaneously and efficiently provide services to multiple user equipments.

Embodiments of the present disclosure provide a network side device in a wireless communication network, including: a receiving unit configured to receive information about a first user equipment; a processing unit configured to, when the first user equipment is determined to be a first type of user equipment based on the information about the first user equipment, multi-layer code data for the first user equipment to obtain a first data stream and a second data stream about the first user equipment, perform a non-orthogonal multiple-access processing of the first data stream and the second data stream of the first user equipment with data for a second user equipment and data for a third user equipment respectively to obtain a first preprocessed data and a second preprocessed data, and pre-code the first preprocessed data and the second preprocessed data respectively, wherein the second user equipment and the third user equipment are a second type of user equipment.

According to embodiments of the present disclosure, wherein the information about the first user equipment includes information about at least one of a location, a channel state, a power, a signal-to-noise ratio, and a signal to interference plus noise ratio of the first user equipment.

According to embodiments of the present disclosure, wherein the processing unit pre-codes the first preprocessed data and the second preprocessed data respectively to obtain a first to-be-transmitted data to be transmitted using a first beam and a second to-be-transmitted data to be transmitted using a second beam.

According to embodiments of the present disclosure, wherein the first type of user equipment is a user equipment located at an edge of a cell and the second type of user equipment is a user equipment located at a center of the cell.

According to embodiments of the present disclosure, wherein the processing unit is further configured to, when the first user equipment is determined to be the second type of user equipment based on the information about the first user equipment, perform non-orthogonal multiple-access processing of the data for the first user equipment with the data for the second user equipment to obtain a third preprocessed data, and pre-code the third preprocessed data and the data for the third user equipment respectively, wherein the second user equipment and the third user equipment are the second type of user equipment.

According to embodiments of the present disclosure, wherein the network side device is at least one of a high altitude platform station, a near-orbit satellite, or a terrestrial base station.

Embodiments of the present disclosure provide a first user equipment in a wireless communication network including: a receiving unit configured to receive user data from a network side device; a processing unit configured to, when the user data includes more than one data stream about the first user equipment, process each data stream to obtain user data about the first user equipment, wherein the each data stream includes data about the first user equipment and data about another user equipment, and combine the user data about the first user equipment obtained by processing the each data stream.

According to embodiments of the present disclosure, the first user equipment further includes: a transmitting unit configured to transmit information about the first user equipment to the network side device in the wireless communication network to cause the network side device to determine a type of the first user equipment based on the information about the first user equipment.

Embodiments of the present disclosure provide a method for wireless communication at a network side device, including: receiving information about a first user equipment; when the first user equipment is determined to be a first type of user equipment based on the information about the first user equipment, multi-layer coding data for the first user equipment to obtain a first data stream and a second data stream about the first user equipment, performing a non-orthogonal multiple-access processing of the first data stream and the second data stream of the first user equipment with data for a second user equipment and data for a third user equipment respectively to obtain a first preprocessed data and a second preprocessed data, and pre-coding the first preprocessed data and the second preprocessed data respectively, wherein the second user equipment and the third user equipment are a second type of user equipment.

According to embodiments of the present disclosure, wherein the information about the first user equipment includes information about at least one of a location, a channel state, a power, a signal-to-noise ratio, and a signal to interference plus noise ratio of the first user equipment.

According to embodiments of the present disclosure, wherein pre-coding the first preprocessed data and the second preprocessed data respectively to obtain a first to-be-transmitted data to be transmitted using a first beam and a second to-be-transmitted data to be transmitted using a second beam.

According to embodiments of the present disclosure, wherein the first type of user equipment is a user equipment located at an edge of a cell and the second type of user equipment is a user equipment located at a center of the cell.

According to embodiments of the present disclosure, wherein, when the first user equipment is determined to be the second type of user equipment based on the information about the first user equipment, performing non-orthogonal multiple-access processing of the data for the first user equipment and the data for the second user equipment with the data for the third user equipment to obtain a third preprocessed data and a fourth preprocessed data, and pre-coding the third preprocessed data and the fourth preprocessed data respectively, wherein the second user equipment and the third user equipment are the second type of user equipment.

According to embodiments of the present disclosure, wherein the network side device is at least one of a high altitude platform station, a near-orbit satellite, or a terrestrial base station.

Embodiments of the present disclosure provide a network side device in a wireless communication network including: a processor, and a memory, the memory storing computer-executable instructions, which, when being executed by the processor, cause the processor to execute the above-described method for wireless communication at the network side device.

Embodiments of the present disclosure provide a first user equipment in a wireless communication network including: a processor, and a memory, the memory storing computer-executable instructions, which, when being executed by the processor, cause the processor to execute the above-described method for wireless communication at the first user equipment.

Embodiments of the present disclosure provide a computer-readable recording medium storing computer-executable instructions, wherein the computer-executable instructions when being executed by the processor cause the processor to execute a method for wireless communication at a network side device or a method for wireless communication at a first user equipment as described above.

The methods provided by the embodiments of the present disclosure to be performed by the network side device and the user equipment in the wireless communication network and the corresponding network side device and the user equipment may take into account both inter-beam and intra-beam interference, effectively remove the effect of interference between the first type of the user equipment of and the second type of the user equipment, improve the overall system efficiency of the wireless communication network, and provide services to multiple user equipments simultaneously and efficiently.

### BRIEF DESCRIPTION OF DRAWINGS

In order to more clearly illustrate the technical solutions of the embodiments of the present disclosure, the accompanying drawings required to be used in the description of the embodiments will be briefly described below. Obviously, the accompanying drawings in the following description are only some exemplary embodiments of the present disclosure, and for a person of ordinary skill in the art, other accompanying drawings may be obtained based on these drawings without any creative labor.

FIG. 1A illustrates a schematic diagram of a wireless communication system according to one embodiment of the present disclosure;

FIG. 1B illustrates a schematic diagram of a wireless communication system in which a HAPS is included, according to one embodiment of the present disclosure;

FIG. 2 illustrates a flowchart of a method for wireless communication at a network side device, according to one embodiment of the present disclosure;

FIG. 3 illustrates a flowchart of a method for wireless communication at a first user equipment according to one embodiment of the present disclosure;

FIG. 4A illustrates an exemplary scenario of an application according to another embodiment of the present disclosure;

FIG. 4B illustrates an exemplary scenario of an application according to another embodiment of the present disclosure;

FIG. 4C illustrates an exemplary scenario of an application according to another embodiment of the present disclosure;

FIG. 5 further illustrates an exemplary diagram of the method for wireless communication shown in FIG. 2 being applied at a network side device, according to one embodiment of the present disclosure;

FIG. 6A illustrates a schematic diagram of a network side device in a wireless communication network, according to one embodiment of the present disclosure;

FIG. 6B illustrates a schematic diagram of a second type of user equipment in a wireless communication network according to one embodiment of the present disclosure;

FIG. 6C illustrates a schematic diagram of another second type of user equipment in a wireless communication network according to one embodiment of the present disclosure;

FIG. 6D illustrates a schematic diagram of a first type of user equipment in a wireless communication network according to one embodiment of the present disclosure;

FIG. 7 illustrates a block diagram of a network side device 700 in a wireless communication pathway according to an embodiment of the present disclosure;

FIG. 8 illustrates a block diagram of a first user equipment 800 in a wireless communication pathway according to an embodiment of the present disclosure;

FIG. 9 is a schematic diagram of a hardware structure of a device involved according to an embodiment of the present disclosure.

### DETAILED DESCRIPTION

In order to make the objects, technical solutions and advantages of the present disclosure more apparent, example embodiments according to the present disclosure will be described in detail below with reference to the accompanying drawings. In the accompanying drawings, the same reference marks denote the same elements throughout. It should be understood that the embodiments described herein are merely illustrative and should not be construed as limiting the scope of the present disclosure. Furthermore, the terminals described herein may include various types of terminals, such as a User Equipment (UE), a mobile terminal (or referred to as a mobile station), or a fixed terminal, however, a terminal and a UE are sometimes used interchangeably hereinafter for convenience. In addition, a receiver and a receiving device are sometimes used interchangeably hereinafter.

Furthermore, in the description of the present disclosure, the terms “first”, “second”, or the like are used only to distinguish descriptions and are not to be understood as indicating or implying relative importance or ordering. In this specification and the accompanying drawings, elements are described in a singular or plural form, depending on the embodiment. However, the singular and plural forms have been appropriately selected for use in the presented embodiments solely for ease of interpretation and are not intended to limit the present disclosure. Thus, the singular form may include the plural form, and the plural form may also include the singular form unless the context clearly indicates otherwise.

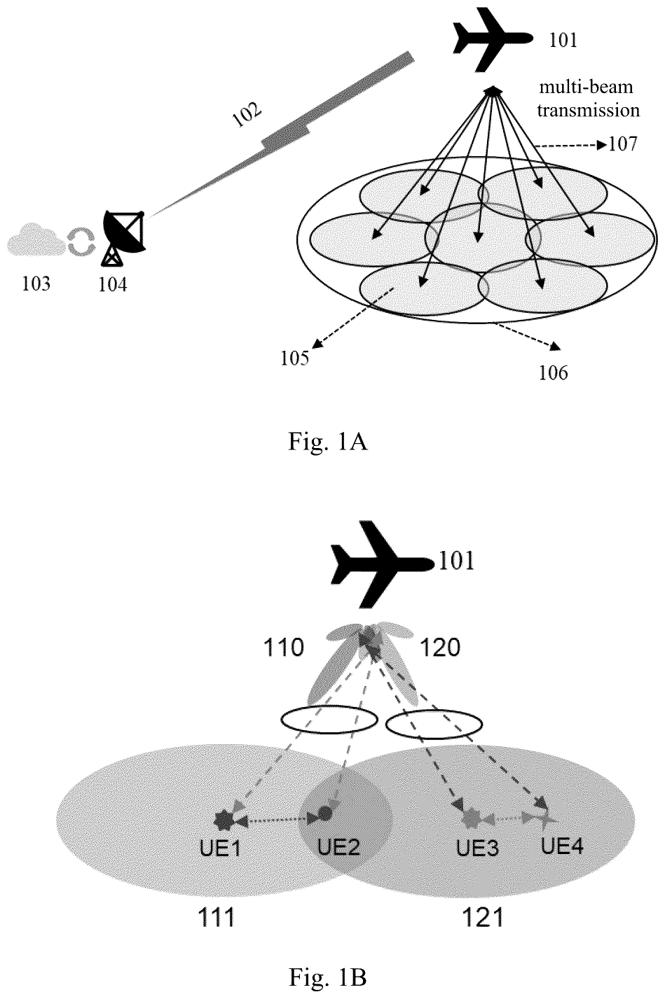

FIG. 1A illustrates a schematic diagram of a wireless communication system according to one embodiment of the present disclosure. In the example shown in FIG. 1A, the wireless communication network may be Non-Terrestrial Networks (NTN). In the example shown in FIG. 1A, a depiction is conducted by describing HAPS 101 as a network side device of the NTN. Alternatively, the network side device may be a near-orbit satellite or the like.

The HAPS 101, as shown in FIG. 1A, is typically 17 to 22 kilometers from the ground. The HAPS 101 may perform data interaction with the Internet 103 by a Feeder Link 102 via a gateway 104. Additionally, the HAPS 101 may utilize multi-beam transmission to transmit multiple beams simultaneously in order to serve multiple cells.

In FIG. 1A, each region 105 is a communication coverage area of one beam, and the region 106 is the entire communication coverage area of a HAPS 101. Each beam emitted by a HAPS 101 may provide communication coverage for its corresponding coverage area (e.g., the region 105) via a communication link 107, and the communication link 107 between the HAPS 101 and the UEs within the communication coverage area may utilize one or more carriers. The communication link 107 shown in FIG. 1A may include an uplink transmission from the UE within the communication coverage area to the network side device 101, or a downlink transmission from the network side device 101 to the UE within the communication coverage area. The downlink transmission may also be referred to as a forward link transmission, while the uplink transmission may also be referred to as a reverse link transmission.

In NTN, the entire communication coverage area of one HAPS is very large and can serve tens of thousands of UEs. Since the HAPS 101 has a limited antenna configuration and processing capacity, and considering the effects of the propagation environment of line-of-sight (LOS) and non-line-of-sight (NLOS) channels in the communication coverage area of the beams, this results in significant interference among user equipments of inter-beam and intra-beam, as illustrated in FIG. 1B.

FIG. 1B illustrates a schematic diagram of a wireless communication system in which a HAPS is included, according to one embodiment of the present disclosure. As an example, only two beams, i.e., communication coverage areas of beam 110 and beam 120, are illustrated in FIG. 1B. Specifically, the region 111 is the communication coverage area of the beam 110, the region 121 is the communication coverage area of the beam 120, and the communication coverage area 111 of the beam 110 is adjacent to the communication coverage area 121 of the beam 120. The UE1 and the UE2 are located within the communication coverage area 111, and the UE1 is located in a center region within the communication coverage area 111, and the UE2 is located in an edge region of the communication coverage area 111. The UE2, the UE3, and the UE4 are located within the communication coverage area 121, and the UE3 and the UE4 are located in a center region within the communication coverage area 121, and UE2 is also located in an edge region of the communication coverage area 121. In this case, there will be interference among the user equipments within the communication coverage area 111, and there will also be interference among the user equipments within the communication coverage area 121, i.e., intra-beam interference. In addition, the user equipment located at the edge of the coverage area may be subject to interference from adjacent beams, i.e., inter-beam interference. For example, the UE2 located in the edge region of the communication coverage area 111 may be subject to interference from the users communicating through the beam 120.

In order to reduce or remove the above-described intra-beam interference or inter-beam interference, the solutions utilizing orthogonal resource allocation (e.g., TDMA or FDMA) or the solutions utilizing effective Multiple Input Multiple Output (MIMO) spatial degrees of freedom (e.g., SDMA) have been proposed in the prior art, but the above-described existing solutions are only for one of the intra-beam interference or the inter-beam interference and cannot be used simultaneously for interference removal for user equipments at cell edge and cell center in two adjacent beams, which greatly reduces the overall system efficiency of the wireless communication network and makes it difficult to efficiently serve more than two user equipments at the same time.

In order to solve the above problems, the present disclosure provides a method that may be performed by a network side device and a user equipment in a wireless communication network, whereby the method provided in the present disclosure may simultaneously remove inter-beam and intra-beam interference to enhance the overall system efficiency of the wireless communication network. The methods performed by the network side device and the user equipment provided by the present disclosure will be described in detail below in connection with the accompanying drawings.

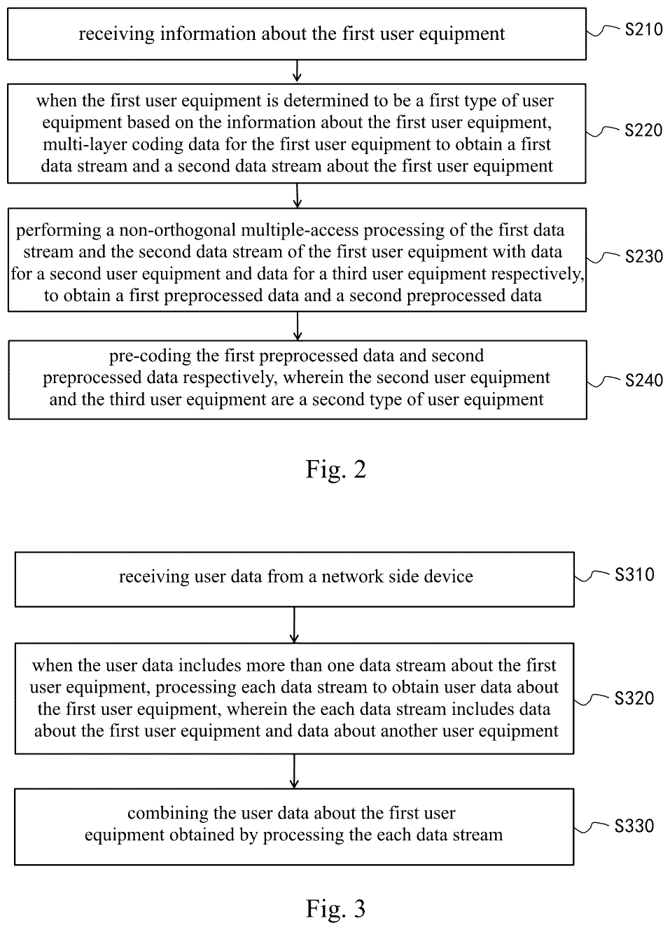

FIG. 2 illustrates a flowchart of a method for wireless communication at a network side device according to one embodiment of the present disclosure. The method shown in FIG. 2 may be performed by a network side device. In the following embodiments, HAPS will be described as an example of a network side device, however, it should be understood that the same method may be applied to network side devices such as, for example, near-orbit satellites, terrestrial base stations, or the like.

As shown in FIG. 2, at step S210, the network side device may receive information about the first user equipment. According to one embodiment of the present disclosure, the network side device may determine a type of the first user equipment based on the information about the first user equipment. The type of user equipment may include a first type and a second type. For example, the type of user equipment may be indicative of the interference being large or small at the user equipment. The interference being large may include at least one of a Signal-to-Noise Ratio (SNR) and a Signal to Interference plus Noise Ratio (SINR) being small, and the interference being small may include at least one of the SNR and the SINR being large. The type of user equipment may include a first type indicative of a large interference at the user equipment and a second type indicative of a small interference at the user equipment. As an example, the user equipment subject to a large interference may be a user equipment at the edge of the cell, and the user equipment subject to a small interference may be a user equipment at the center of the cell. For example, in the example shown in FIG. 1B, the UE1, the UE3, or the UE4 is a user equipment at the center of the cell, i.e., the UE1, the UE3, or the UE4 is a second type of user equipment; and the UE2 is a user equipment at the edge of the cell, i.e., the UE2 is a first type of user equipment.

According to one embodiment of the present disclosure, the information about the first user equipment may include information about a location of the first user equipment. The network side device may determine that the first user equipment is a first type of user equipment or a second type of user equipment based on the information about the location of the first user equipment. According to another embodiment of the present disclosure, the information about the first user equipment may include information about at least one of a channel state, a receiving power, a signal-to-noise ratio, and a signal to interference plus noise ratio. The network side device may determine a channel state of the first user equipment based on the information about at least one of the channel state, the receiving power, the signal-to-noise ratio, and the signal to interference plus noise ratio, thereby determining that the first user equipment is a first type of user equipment or a second type of user equipment.

Furthermore, according to one embodiment of the present disclosure, the first user equipment may measure at least one of its location and channel state, and include the measurement result in the information about the first user equipment, which is fed back to the network side device via an uplink control information (UCI) signaling, a Radio Resource Control (RRC) signaling, or a Medium Access Control (MAC) Control Element (CE) signaling, etc., so that the network side device can determine whether the first user equipment is a first type of user equipment or a second type of user equipment

For example, the measurement may be based on existing Reference Signal Receiving Power (RSRP) measurements, Reference Signal Receiving Quality (RSRQ) measurements, Channel State Information-Reference Signal (CSI-RS) measurements, or other new Reference Signal (RS) that may be used for the measurement to determine the channel state at the first user equipment. Specifically, the measurements may be specific CSI information (e.g., channel information), RSRQ information (e.g., SINR information), or RSRP information (e.g., SNR information) having reduced channel accuracy and reduced feedback overhead to determine the channel state at the first user equipment.

In addition, the first user equipment may estimate the location of the first user equipment based on a global navigation satellite system (GNSS), a global positioning system (GPS), or a Beidou Navigation Satellite Navigation System (BDS), among other capabilities, and report the estimated location to the network side device via the UCI signaling, RRC signaling or MAC CE signaling to determine the location of the first user equipment. The first user equipment may also estimate the location of the first user equipment based on the downlink RS used for localization or sensing, and report the estimated location to the network side device via the UCI signaling, RRC signaling or MAC CE signaling to determine the location of the first user equipment. At this point, the measurement may be the location, the Relative Time Of Arrival (RTOA), or the Round Trip Delay (RTT), etc. of the first user equipment. The downlink RS for positioning or sensing may be a Positioning Reference Signal (PRS) as defined in 5G or other new RS for positioning or sensing as defined in future systems.

Alternatively, the network side device may, e.g., via the uplink RS, measure at least one of the location and the channel state of the first user equipment to determine whether the first user equipment is a first type of user equipment or a second type of user equipment.

For example, the network side device may measure at least one of the location and the channel state of the first user equipment using a channel sounding reference signal (SRS) for uplink channel estimation.

As another example, the network side device may estimate the location of the first user equipment based on the uplink RS used for localization or sensing. At this point, the measurement may be a location, a Relative Time Of Arrival (RTOA), or a Round Trip Delay (RTT), among others of the first user equipment. The uplink RS used for localization or sensing may be an SRS defined in 5G or other new RS defined in future systems for localization or sensing.

Again, for example, the network side device may estimate the location of the first user equipment based on the uplink and/or downlink signals used for localization or sensing. In order to estimate the location of the first user equipment, separate or integrated communication and sensing functions may be available at the network side device as desired.

Furthermore, according to another example of the present disclosure, in order to determine at least one of the location and the channel state of the first user equipment at the network side device, other information, such as weather conditions or the distribution of rain or clouds in the communication coverage area of the network side device, may also be measured or sensed at the network side device to be used to reflect the current channel state information.

With continued reference to FIG. 2, at step S220, when the first user equipment is determined to be a first type of user equipment based on the information about the first user equipment, a multi-layer coding (MLC) is performed on the data for the first user equipment to obtain a first data stream and a second data stream about the first user equipment. For example, the first type of user equipment may be the UE2 shown in FIG. 1B.

Then, at step S230, the Non-Orthogonal Multiple-access (NOMA) processing is performed for the first data stream of the first user equipment and the data for the second user equipment to obtain the first preprocessed data, wherein the second user equipment may be the UE1 shown in FIG. 1B. The NOMA processing is performed for the second data stream of the first user equipment and the data for the third user equipment to obtain the second preprocessed data, wherein the third user equipment may be at least one of the UE3 and the UE4 illustrated in FIG. 1B, and wherein the intra-beam interference may be removed by the above NOMA processing.

Finally, at step S240, the first preprocessed data and the second preprocessed data are separately pre-coded respectively. By pre-coding the first preprocessed data and the second preprocessed data respectively, the SDMA processing may be performed for the first preprocessed data and the second preprocessed data to be transmitted, wherein the inter-beam interference may be removed by the above-described SDMA processing. For example, in step S240, the pre-coding may be performed for the first preprocessed data and the second preprocessed data respectively, so as to obtain a first to-be-transmitted data to be transmitted using the first beam and a second to-be-transmitted data to be transmitted using the second beam, and then the first to-be-transmitted data and the second to-be-transmitted data may be transmitted utilizing the MIMO so as to cover signals to all of the UEs within the corresponding communication coverage area.

In addition, in order to make it easier for the user equipment to decode the received signals, the network side device may assign different powers for the data about different user equipments, such as assigning a high power for the data about the second type of user equipment and a low power for the data about the first type of user equipment, and vice versa. Alternatively, different multiple-access signatures, such as spread spectrum sequences, scrambled sequences, interleaved sequences, or the like, may be assigned to the data about different user equipments.

As can be seen from the above-described data processing method performed by the above-described network side device provided by the present disclosure, the above-described method provided by the present disclosure effectively removes the interference of the first type of user equipment and the second type of user equipment while simultaneously taking into account both inter-beam and intra-beam interference, and thus enhances the overall system efficiency of the wireless communication network, so as to simultaneously and efficiently provide service to at least three users.

The method performed at a network device for the case in which the first user equipment is a first type of user equipment is described above in connection with FIG. 2. According to another example of the present disclosure, the method performed at the network device may also include a situation in which, when the first user equipment is not the first type of user equipment but is the second type of user equipment, a NOMA process is performed for the data for the first user equipment and the data for the second user equipment to obtain a third preprocessed data, e.g., the first user equipment may be the UE3 as shown in FIG. 1B, the second user equipment may be the UE4 shown in FIG. 1B, and the intra-beam interference may be removed by the NOMA processing described above. Then, the third preprocessed data and the data for the third user equipment are pre-coded separately, for example, the third user equipment may be the UE1 shown in FIG. 1B. By pre-coding the third preprocessed data and the data for the third user equipment separately, the SDMA processing may be performed for the third preprocessed data and the data for the third user equipment to be transmitted, wherein inter-beam interference can be removed by the above-described SDMA processing. For example, the third preprocessed data and the data for the third user equipment may be pre-coded to obtain the third to-be-transmitted data to be transmitted using the third beam and the fourth to-be-transmitted data to be transmitted using the fourth beam, and the third to-be-transmitted data and the fourth to-be-transmitted data may be transmitted utilizing MIMO to cover the signal to all of the UEs within the corresponding communication coverage area.

In addition, in order to make it easier for the user equipments to decode the received signals, the network side device may assign different powers for the data about different user equipments, such as assigning a high power for the data about the second type of user equipment and a low power for the data about the first type of user equipment, and vice versa. Alternatively, different multiple-access signatures, such as spread spectrum sequences, scrambled sequences, interleaved sequences, or the like, may be assigned to the data about different user equipments.

As can be seen from the above data processing method performed by the network side device provided by the present disclosure, the above method provided by the present disclosure does not require separate signal processing methods to be designed for different scenarios, and the same method can be used for different types of user equipments under all the scenarios respectively. This effectively removes interference of the first type of user equipment and the second type of user equipment when both inter-beam and intra-beam interference are considered, thereby enhancing the overall system efficiency of the wireless communication network, and making it possible to provide services to at least three users simultaneously and efficiently.

Above, a method applied to a network side device according to embodiments of the present disclosure is described. In the following, a method applied to a user equipment according to embodiments of the present disclosure will be described with reference to FIG. 3. FIG. 3 illustrates a flowchart of a method for wireless communication at a first user equipment according to one embodiment of the present disclosure.

Referring to FIG. 3, the method may be performed by a first user equipment, such as the UE2 shown in FIG. 1B, and the method may include the following steps.

At step S310, the first user equipment may receive user data from a network side device, such as receiving a signal transmitted by the network side device utilizing the MIMO.

At step S320, when the user data includes more than one data stream about the first user equipment, the first user equipment may process each data stream to obtain user data about the first user equipment, where each data stream includes data about the first user equipment and data about another user equipment.

According to an example of the present disclosure, the user data may include two data streams about the first user equipment, indicating that the first user equipment is a first type of user equipment at this time. For example, the user data may include two data streams including a data stream including the first preprocessed data and a data stream including the second preprocessed data with respect to the UE2 as shown in FIG. 1B, and the UE2 is being served by both the beams 110 and 120.

At step S330, user data about the first user equipment obtained by processing each data stream is combined.

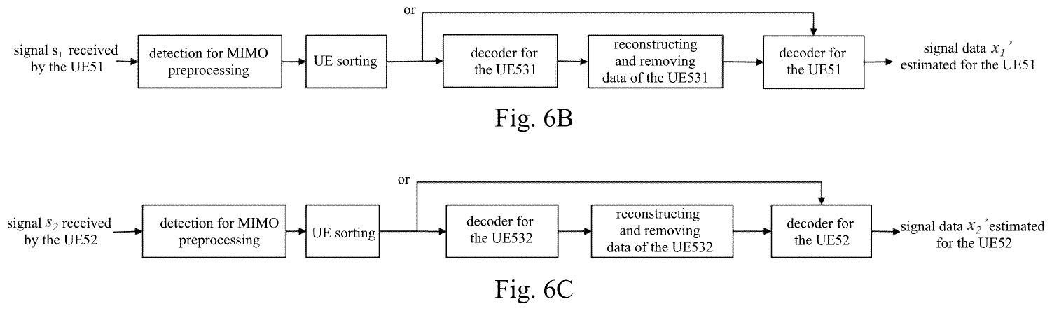

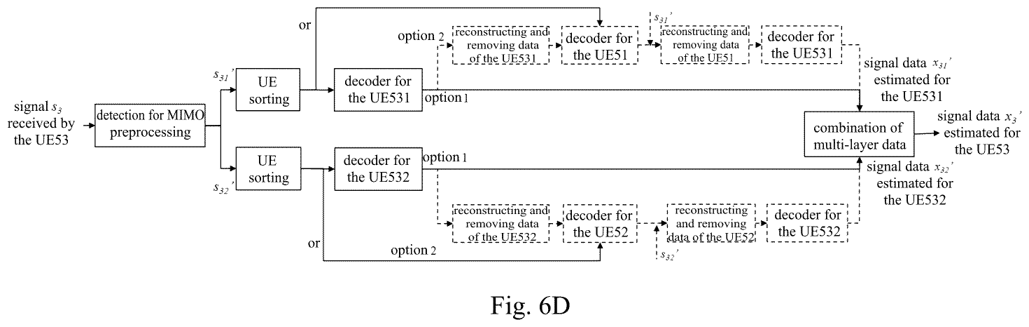

According to one example of the present disclosure, the first user equipment may process each of the two data streams to obtain user data about the first user equipment. For example, interference removal may be performed for each data stream. This will be further described below in connection with FIG. 6D. The first user equipment then combines the user data about the first user equipment obtained by processing each of the above two data streams. For example, the above combination is carried out by way of performing a combination of multiple layers of data to obtain estimated signal data for the first user equipment.

From the method applied to a user equipment according to embodiments of the present disclosure described above in conjunction with FIG. 3, it can be seen that the first user equipment can be well served by the two beams, and the effects of inter-beam interference and intra-beam interference are effectively removed.

User data including more than one data stream about the first user equipment is described above in connection with FIG. 3. According to another example of the present disclosure, the method applied to a user equipment may further include a situation in which, when the user data includes only one data stream about the first user equipment, the data stream is processed to obtain user data about the first user equipment, wherein the data stream includes data about the first user equipment and data about another user equipment.

As an example, the first user equipment may be the UE1, UE3, or UE4 shown in FIG. 1B. The other user equipment may be the UE2 shown in FIG. 1B.

As an example, when the user data includes only one data stream about the first user equipment, it is indicated that the first user equipment is a second type of user equipment at that time.

As an example, the one data stream described above may include a data stream of the first preprocessed data described above or a data stream of the second preprocessed data described above.

The first user equipment processes the one data stream to obtain user data about the first user equipment, as will be described in detail below in connection with FIG. 6B or 6C.

As a result, the first user equipment is then well served by one beam and the effects of intra-beam and inter-beam interference are effectively removed.

According to embodiments of the present disclosure, the method for wireless communication at a first user equipment may further include the step of transmitting information about the first user equipment to a network side device in a wireless communication network to cause the network side device to determine a type of the first user equipment based on the information about the first user equipment. Content related to the information about the first user equipment may be referred to as described above with reference to FIG. 2.

As can be seen from the method for wireless communication at the first user equipment described above with reference to FIG. 3, the method provided by the present disclosure takes into account both inter-beam and intra-beam interference, efficiently removes interference of the first type of user equipment and the second type of user equipment, improves the overall system efficiency of the wireless communication network, and serves the at least three user equipments simultaneously and efficiently.

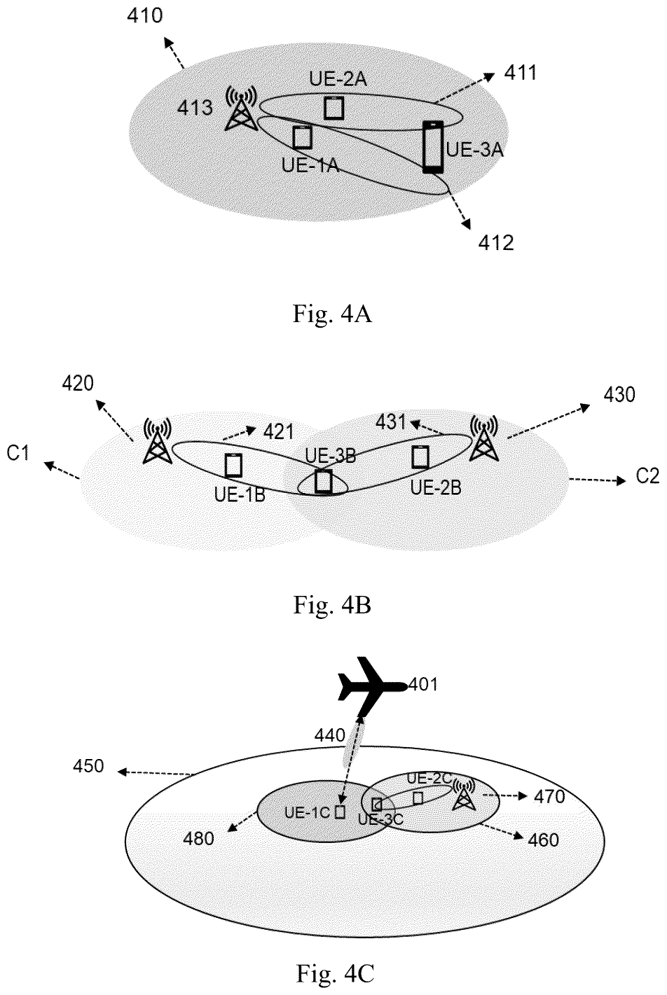

The method provided by the present disclosure may be applied in addition to the exemplary cases described above in conjunction with FIG. 1B, to scenarios in which at least one of inter-beam interference and intra-beam interference is strong and in which interference suppression by MIMO cannot be further performed. Specifically, the method provided in the present disclosure can also be applied to conventional cellular systems, such as the scenarios shown in FIGS. 4A and 4B; sky-ground integrated systems, such as the scenario shown in FIG. 4C, or the like. The above application scenarios will be described below in conjunction with the accompanying FIGS. 4A through 4C.

FIG. 4A illustrates an exemplary scenario of an application according to another embodiment of the present disclosure. Referring to FIG. 4A, the exemplary scenario shown in FIG. 4A is an exemplary scenario of applying the method provided by the present disclosure to a user equipment within the same cell in a conventional cellular system. The base station 413 and the UE-1A through UE-3A shown in FIG. 4A are all located within the same cell 410. The UE-1A and UE-2A are located in a communication coverage area 412 of beam 414 (not shown) and a communication coverage area 411 of beam 415 (not shown) respectively. The communication coverage area 411 and the communication coverage area 412 cover only a portion of the UE-3A. the UE-3A is a first type of user equipment, and the UE-1A and the UE-2A are a second type of user equipment. The UE-3A covered by the communication coverage area 411 is subject to interference from the beam 414. The UE-3A covered by the communication coverage area 412 is subject to interference from the beam 415. Interference may exist between UE-2A and UE-3A within the communication coverage area 411. Interference will exist between the UE-1A and the UE-3A within the communication coverage area 412. In the above case, the base station 413 may apply the method described above in conjunction with FIG. 2 provided by the present disclosure to simultaneously communicate with the UE-1A, the UE-2A, and the UE-3A.

FIG. 4B illustrates an exemplary scenario of an application according to another embodiment of the present disclosure. Referring to FIG. 4B, the exemplary scenario shown in FIG. 4B is an exemplary scenario of applying the method provided by the present disclosure to a user equipment within an adjacent cell in a conventional cellular system. The base station 420 and UE-1B and UE-3B shown in FIG. 4B are all located in the same cell C1, the base station 430 and UE-2B and UE-3B are all located in another same cell C2, and the UE-3B is located in an adjacent area of the cell C1 and the cell C2. The UE-1B and UE-3B are located in a communication coverage area 421 of the beam 422 (not shown), and the UE-2B and UE-3B are located in the communication coverage area 431 of beam 432 (not shown). The communication coverage area 421 and the communication coverage area 431 completely cover UE-3B, i.e., UE-3B is disposed in an overlapping region of the communication coverage area 421 and the communication coverage area 431. UE-3B is a first type of user equipment, and UE-1B and UE-2B are a second type of user equipment. The UE-3B covered by the communication coverage area 421 is subject to interference from the beam 432. The UE-3B covered by the communication coverage area 431 is subject to interference from the beam 422. Interference may exist between UE-1B and UE-3B within the communication coverage area 421. Interference may exist between UE-2B and UE-3B within the communication coverage area 431. In the above-described case, the base station 420 may apply the above-described method provided by the present disclosure in conjunction with FIG. 2 to communicate with the UE-1B and the UE-3B. The base station 430 may apply the method described above in conjunction with FIG. 2 provided by the present disclosure to communicate with the UE-2B and the UE-3B.

FIG. 4C illustrates an exemplary scenario of an application according to another embodiment of the present disclosure. Referring to FIG. 4C, the exemplary scenario shown in FIG. 4C is an exemplary scenario of applying the method provided in the present disclosure to a user equipment in a sky-ground integrated system. As shown in FIG. 4C, the system including the network side device 401 is an NTN system, and the system including the base station 470 is a TN system. The area 450 is a communication coverage area of the entire NTN system. The area 480 is a communication coverage area of one of the beams 440 of the NTN system. The area 460 is a communication coverage area of the base station 470. As shown in FIG. 4C, UE-1C and UE-3C are located within the communication coverage area 480, and UE-2C and UE-3C are located within the communication coverage area 460. The communication coverage area 480 and the communication coverage area 460 completely cover the UE-3C, i.e., the UE-3C is disposed in an adjacent area of the communication coverage area 460 and the communication coverage area 480. The UE-3C is a first type of user equipment, and the UE-1C and the UE-2C are a second type of user equipment. The UE-3C covered by the communication coverage area 460 is subject to interference from the beam 440. The UE-3C covered by the communication coverage area 480 is subject to interference from beams coming from the base station 470. Interference may exist between the UE-1C and the UE-3C covered by the communication coverage area 480. Interference may exist between the UE-2C and the UE-3C in the communication coverage area 460. In the above case, the network side device 401 may apply the method described above in conjunction with FIG. 2 provided in the present disclosure to communicate with the UE-1C and the UE-3C. The base station 470 may apply the method described above in conjunction with FIG. 2 provided by the present disclosure to communicate with the UE-2C and the UE-3C.

As can be seen from the above-described scenarios in which the above-described method provided by the present disclosure in conjunction with FIGS. 4A to 4C can be applied, the above-described method provided by the present disclosure can be applied in a wireless communication network with various settings, and is characterized by a wide range of applicability.

In order to make the foregoing clearer, the method provided in the present disclosure for wireless communication at a network side device will next be further described in connection with examples.

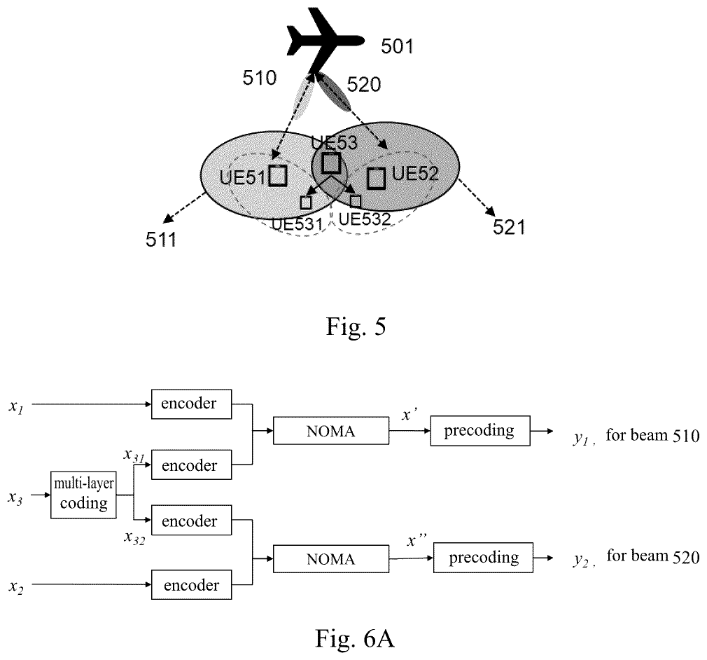

FIG. 5 further illustrates an example diagram of a method applied to the wireless communication shown in FIG. 2 at a network side device, according to one embodiment of the present disclosure. FIG. 6A illustrates a schematic diagram of a network side device in a wireless communication network according to one embodiment of the present disclosure. FIG. 6B illustrates a schematic diagram of a second type of user equipment in a wireless communication network according to one embodiment of the present disclosure. FIG. 6C illustrates a schematic diagram of another second type of user equipment in a wireless communication network according to one embodiment of the present disclosure. FIG. 6D illustrates a schematic diagram of a first type of user equipment in a wireless communication network according to one embodiment of the present disclosure.

Referring to FIG. 5, as an example, only two beams of the network side device 501 are shown, namely beams 510 and 520. The area 511 is a communication coverage area of the beam 510, and the area 521 is a communication coverage area of the beam 520.

The first user equipment may be a UE51, a UE52, or a UE53. The UE51, the UE52, and the UE53 feed information about themselves to the network side device 501, such as an estimated location, a measured channel state, and among other information respectively. The network side device 501 may receive the above information according to step 210 shown in FIG. 2. The network side device 501 may determine, after processing, that the UE51 and the UE53 are within the communication coverage area 511, that the UE52 and the UE53 are within the communication coverage area 521, and that the UE53 is within an adjacent area of the communication coverage areas 511 and 521. The network side device 501 may determine that the UE53 is a first type of user equipment and the UE51 and the UE52 are a second type of user equipments, i.e., the UE53 is a first type of user equipment that is subjected to a large interference, and the UE51 and the UE52 are a second type of user equipment that are subjected to a small interference, according to the step S220 illustrated in FIG. 2.

In this case, the user equipment within the communication coverage area 511 is subject to interference from the beam 520, i.e., inter-beam interference. The user equipment within the communication coverage area 521 is subject to interference from the beam 510, i.e., inter-beam interference. Interference may exist among the user equipments within the communication coverage area 511, and interference may exist among user equipments within the communication coverage area 521, i.e., intra-beam interference.

FIG. 6A-FIG. 6D illustrate schematic diagrams of network side devices and user equipments in a wireless communication network according to embodiments of the present disclosure. In the following, the transmitting and receiving processes of the network side device and the user equipment shown in FIG. 5 will be described with reference to FIG. 6A-FIG. 6D.

In order to remove the above-described inter-beam and intra-beam interference, the data to be transmitted to a plurality of user equipments may be processed using a network side device such as the one shown in FIG. 6A, according to embodiments of the present disclosure. In the example shown in FIG. 6A, x₁ is data for UE51, x₂ is data for UE52, and x₃ is data for UE53.

Referring to FIG. 6A, first, according to step S220 shown in FIG. 2, a multi-layer coding process will be performed for the data x₃ to obtain a first data stream x₃₁ and a second data stream x₃₂, at which time the UE53 is logically divided into two user sub-devices, such as UE531 and UE532 illustrated in FIG. 5, wherein the UE531 may be localized to be within the same communication coverage area 511 as the UE51, and the UE532 may be localized to be within the same communication coverage area 521 as the UE52.

Then, according to step S230 shown in FIG. 2, the data of the first data stream x₃₁ coded by an encoder is subjected to the NOMA processing with the data x₁ coded by an encoder to obtain the first preprocessed data x′; the data of the second data stream x₃₂ coded by an encoder is subjected to the NOMA processing with the data x₂ coded by an encoder to obtain the second preprocessed data x″;

Finally, according to step S240 shown in FIG. 2, pre-coding processing is performed for the first pre-processed data x′ and the second pre-processed data x″ respectively, to obtain data y₁ for the beam 510 and data y₂ for the beam 520, and then the transmitter transmits, via the beam 510, the data y₁ to all UEs within the communication coverage area 511, and transmits, via the beam 520, the data y₂ to all UEs within the communication coverage area 521. In order to be able to more easily decode the received signals by the user equipment, the network side device 501 may allocate different powers for the data about different user equipments, such as allocating a high power for the data about the UE53 (including the UE531 and the UE532) and a low power for the data about UE51 and UE52, and vice versa.

FIG. 6B and FIG. 6C illustrate schematic diagrams of data reception processing for a second type of UE corresponding to the network side device shown in FIG. 6A respectively.

According to embodiments of the present disclosure, in order to remove the above-described inter-beam and intra-beam interference, the received signals may be processed using a user equipment as shown in FIG. 6B. In the example shown in FIG. 6B, s₁ is a signal received by the UE51 illustrated in FIG. 5, and x₁′ is estimated signal data for the UE51.

Referring to FIG. 6B, the UE51 receives the signal s₁ from the network side device via the beam 510, and as can be seen from the above described in conjunction with FIG. 5, at this time, the data stream in the signal s₁ includes the data about the UE51 and the data about the UE531. The UE51 may obtain data about the UE51 from the signal s₁.

According to an example of the present disclosure, the data about the UE51 and the data about the UE531 may have different powers. For example, the data about the UE51 has a higher power than the data about the UE531, or the data about the UE51 has a lower power than the data about the UE531.

According to another example of the present disclosure, the data about the UE51 and the data about the UE531 may have different SNRs or SINRs. For example, the data about the UE51 has a SNR or SINR that is larger than the SNR or SINR that the data about UE531 has, or the data about the UE51 has a SNR or SINR that is smaller than the SNR or SINR that the data about UE531 has.

The UE51 may sort at least one of the power, the SNR, and the SINR that the data about the UE51 and the UE531 has. Depending on whether the result of the sorting satisfies a predetermined condition, the UE51 performs a corresponding operation. For example, when the result of the sorting satisfies the predetermined condition, the UE51 does not perform the operation of interference removal. When the result of the sorting does not satisfy the predetermined condition, the UE 51 performs the operation of interference removal.

As an example, the predetermined condition may be that the data about the UE51 has at least one of the power, the SNR and the SINR much higher than at least one of the power, the SNR and the SINR that the data about UE531 has. In practice, the predetermined condition will be related to the Modulation and Coding Scheme (MCS); the higher the MCS, the greater the “much higher” in the predetermined condition. For example, as the MCS is higher, the predetermined condition may be that the data about the UE51 has at least one of the power, the SNR, the SINR 10 dB higher than the at least one of the power, the SNR and the SINR that the data about the UE531 has. It should be noted that “10 dB” is just an example, which may also be other values.

When the result of the sorting satisfies the predetermined condition described above, the UE 51 may, instead of performing the interference removal operation, perform the following operation: directly inputting the data of the signal s₁ after passing through detection for MIMO preprocessing into the decoder for the UE51 to decode the data about the UE51, thereby obtaining the estimated signal data x₁′ for the UE51, thereby realizing the efficient communication between the UE51 and the network side device.

When the result of the sorting does not satisfy the predetermined condition described above, the UE51 performs an operation of interference removal. For example, when the result of the sorting is that at least one of the power, the SNR, and the SINR that the data about the UE51 has is slightly higher than at least one of the power, the SNR, and the SINR that the data about the UE531 has, or at least one of the power, the SNR, and the SINR that the data about the UE51 has is lower than at least one of the power, the SNR, and the SINR that the data about the UE531 has, the UE51 may perform the following operation of interference removal: firstly, the data of the signal s₁ after passing through the detection for MIMO preprocessing is input into a decoder for the UE531 to decode a data stream that includes the data about the UE531, and at this time, the data stream also includes data about the UE51 not being decoded, the data about the UE531 being interfering data for the UE51. Next, the data stream including the data about the UE531 is subject to the reconstruction and removal of the data about the UE531 to obtain a data stream including only the data about the UE51. Finally, the data stream including only the data about the UE51 is input into a decoder for the UE51 to decode the data about the UE51, thereby obtaining the estimated signal data x₁′ for the UE51, thereby realizing efficient communication between the UE51 and the network side device with removal of interference.

According to embodiments of the present disclosure, in order to remove the above-described inter-beam and intra-beam interference, the received signal may be processed using a user equipment as shown in FIG. 6C. In the example shown in FIG. 6C, s₂ is the signal received by the UE52 illustrated in FIG. 5, and x₂′ is the estimated signal data for the UE52.

Referring to FIG. 6C, the UE52 receives the signal s₂ from the network side device via the beam 520, and as can be seen from the above described in conjunction with FIG. 5, at this time, the data stream in the signal s₂ includes data about the UE52 and data about the UE532. The UE52 may obtain the data about the UE52 from the signal s₂.

According to one example of the present disclosure, the data about the UE52 and the data about the UE532 may have different powers. For example, the data about UE52 has a higher power than the data about UE532, or the data about UE52 has a lower power than the data about UE532.

According to another example of the present disclosure, the data about the UE52 and the data about the UE532 may have different SNRs or SINRs. For example, the data about the UE52 has a SNR or SINR that is larger than the SNR or SINR that the data about the UE532 has, or the data about the UE52 has a SNR or SINR that is smaller than the SNR or SINR the data about the UE532 has.

The UE52 may sort at least one of the power, the SNR, and the SINR that the data about the UE52 and the UE532 has. Depending on whether the result of the sorting satisfies a predetermined condition, the UE52 performs a corresponding operation. For example, when the result of the sorting satisfies the predetermined condition, the UE52 does not perform the operation of interference removal. When the result of the sorting does not satisfy the predetermined condition, the UE52 performs the operation of interference removal.

As an example, the predetermined condition may be that the data about the UE52 has at least one of the power, the SNR, and the SINR much higher than at least one of the power, the SNR and the SINR that the data about the UE532 has. In practice, the predetermined condition will be related to the Modulation and Coding Scheme (MCS); the higher the MCS, the greater the “much higher” in the predetermined condition. For example, as the MCS is higher, the predetermined condition may be that the data about the UE52 has at least one of the power, the SNR and the SINR 10 dB higher than at least one of the power, the SNR and the SINR that the data about the UE532 has. It should be noted that “10 dB” is just an example, which may also be other values.

When the result of the sorting satisfies the predetermined condition described above, the UE52 may, instead of performing the interference removal operation, perform the following operation: directly inputting the data of the signal s₁ after passing through detection for MIMO preprocessing into the decoder for the UE52 to decode the data about the UE52, thereby obtaining the estimated signal data x₁′ for the UE52, thereby realizing the efficient communication between the UE52 and the network side device.

When the result of the sorting does not satisfy the predetermined condition described above, the UE52 performs an operation of interference removal. For example, when the result of the sorting is that at least one of the power, the SNR, and the SINR that the data about the UE52 has is slightly higher than at least one of the power, the SNR, and the SINR that the data about the UE532 has, or at least one of the power, the SNR, and the SINR that the data about the UE52 has is lower than at least one of the power, the SNR, and the SINR that the data about the UE532 has, the UE52 may perform the following operation of interference removal: firstly, the data of the signal s₂ after passing through the detection for MIMO preprocessing is input into a decoder for the UE532 to decode a data stream that includes the data about the UE532, and at this time, the data stream also includes data about the UE52 not being decoded, the data about the UE532 being interfering data for the UE52. Next, the data stream including the data about the UE532 is subject to the reconstruction and removal of the data about the UE532 to obtain a data stream including only the data about the UE52. Finally, the data stream including only the data about the UE52 is input into a decoder for the UE52 to decode the data about the UE52, thereby obtaining the estimated signal data x₂′ for the UE52, thereby realizing efficient communication between the UE52 and the network side device with removal of interference.

FIG. 6D illustrates a schematic diagram of data reception processing for a first type of UE corresponding to the network side device shown in FIG. 6A.

According to embodiments of the present disclosure, in order to remove the above-described inter-beam and intra-beam interference, the received signals may be processed using a user equipment as shown in FIG. 6D. In the example shown in FIG. 6D, s₃ is the signal received by the UE53 illustrated in FIG. 5, and x₃′ is the estimated signal data for the UE53.

Referring to FIG. 6D, the UE53 may receive the signal s₃ from the network side device via beam 510 and beam 520 according to step S310 shown in FIG. 3.

After signal s₃ passes through the detection for the MIMO preprocessing, it will get two data streams, namely a data stream s₃₁′ and a data stream s₃₂′ respectively, wherein the data stream s₃₁′ includes data about the UE531 and data about the UE51, and for the UE53, the data about the UE51 is interfering data; the data stream s₃₂′ includes data about UE532 and data about UE52, and for UE53, the data about UE52 is interfering data. The UE53 may obtain data about the UE53 from the data stream s₃₁′ and the data stream s₃₂′.

According to an example of the present disclosure, for the data stream s₃₁′, the data about the UE531 and the data about the UE51 may have different powers. For example, the data about the UE531 has a higher power than the data about the UE51, or the data about the UE531 has a lower power than the data about the UE51. According to another example of the present disclosure, the data about the UE531 and the data about the UE51 may have different SNRs or SINRs. For example, the data about the UE531 has a SNR or SINR that is larger than the SNR or SINR that the data about the UE51 has, or the data about the UE531 has a SNR or SINR that is smaller than the SNR or SINR that the data about the UE51 has.

According to an example of the present disclosure, for the data stream s₃₂′, the data about the UE532 and the data about the UE52 may have different powers. For example, the data about UE532 has a higher power than the data about UE52, or the data about UE532 has a lower power than the data about UE52. According to another example of the present disclosure, the data about the UE532 and the data about the UE52 may have different SNRs or SINRs. For example, the data about the UE532 has a SNR or SINR that is larger than the SNR or SINR that the data about UE52 has, or the data about the UE532 has a SNR or SINR that is smaller than the SNR or SINR that the data about the UE52 has.

With respect to the data stream s₃₁′, the UE53 may sort at least one of the power, the SNR, and the SINR that the data about the UE531 and the UE51 has. Depending on whether the result of the sorting satisfies a predetermined condition, the UE53 performs a corresponding operation. For example, when the result of the sorting satisfies the predetermined condition, the UE53 may choose to perform or not to perform the operation of interference removal based on the equipment performance of the UE53 itself. When the result of the sorting does not satisfy the predetermined condition, the UE53 performs the operation of interference removal.

As an example, the predetermined condition may be that the data about the UE531 has at least one of the power, the SNR, and the SINR much higher than at least one of the power, the SNR, and the SINR that the data about UE51 has. In practice, the predetermined condition will be related to the Modulation and Coding Scheme (MCS); the higher the MCS, the greater the “much higher” in the predetermined condition. For example, as the MCS is higher, the predetermined condition may be that the data about the UE531 has at least one of the power, the SNR and the SINR 10 dB higher than the at least one of the power, the SNR and the SINR that the data about UE51 has. It should be noted that “10 dB” is just an example, which may also be other values.

When the result of the sorting does not satisfy the predetermined condition described above, the UE53 performs an operation of interference removal. For example, when the result of the sorting is that at least one of the power, the SNR, and the SINR that the data about the UE531 has is lower or slightly higher than at least one of the power, the SNR, and the SINR that the data about the UE51 has, the UE53 may perform the interference removal operation as follows: according to the step S320 illustrated in FIG. 3, the data stream s₃₁′ is first input into a decoder for the UE51 to decode a data stream including the data about the UE51, and at this time, the data stream also includes data about the UE531 not being decoded. Then, a reconstruction and removal operation of the data of the UE51 is performed on the data stream of the data about the UE51 to obtain a data stream including only the data of the UE531. Finally, the data stream including only the data about the UE531 is input into a decoder for the UE531 to obtain the decoded data stream including only the data about the UE531, and thus the estimated signal data x₃₁′ for the UE531 is obtained.

When the result of the sorting satisfies the predetermined conditions described above, the UE53 may choose whether to perform or not to perform the operation of interference removal according to the equipment performance of the UE53 itself. Specifically, the UE53 may perform the following operation: according to step S320 shown in FIG. 3, a data stream s₃₁′ is first input into a decoder for the UE531 to decode a data stream including the data about the UE531, and at this time, the data stream also includes the data about the UE51 not being decoded. The UE53 may then determine whether to perform the interference removal operation based on its own processing capability, wherein the processing capability of the UE53 may include a device performance of the UE, such as a CPU performance, a motherboard performance, or the like. When the processing capability of the UE53 is weak, the signal data x₃₁′ estimated for the UE531 may be obtained directly without applying interference removal (i.e., Option 1 illustrated in FIG. 6D) to the data stream including the data about the UE531. When the processing capability of the UE53 is strong, the interference removal may be applied to the data stream including the data about the UE531 (i.e., option 2 illustrated in FIG. 6D), specifically, a reconstruction and removal operation of the data about the UE531 is performed on the data stream of the data about the UE531, and at this time, the data stream also includes the data about the UE51 not being decoded, to obtain a data stream that only includes the data of the UE51; then the data stream that includes only the data of the UE51 is input into a decoder for the UE51 to obtain a decoded data stream that includes only the data of the UE51; next, based on the data stream of the data about the UE531 and the decoded data stream that includes only the data of the UE51, the reconstruction and removal operation of the data of UE51 is performed to obtain a data stream that includes only the data about the UE531; and finally, the data stream including only the data about the UE531 is input into a decoder for the UE531 to obtain the decoded data stream including only the data about the UE531, and thus the estimated signal data x₃₁′ for the UE532 is obtained.

With respect to the data stream s₃₂′, the UE53 may sort at least one of the power, the SNR, and the SINR that the data about the UE532 and the UE52 has. Depending on whether the result of the sorting satisfies a predetermined condition, the UE53 performs a corresponding operation. For example, when the result of the sorting satisfies the predetermined condition, the UE53 may choose to perform or not to perform the operation of interference removal based on the equipment performance of the UE53 itself. When the result of the sorting does not satisfy the predetermined condition, the UE53 performs the operation of interference removal.

As an example, the predetermined condition may be that the data about the UE532 has at least one of the power, the SNR, and the SINR much higher than at least one of the power, the SNR, and the SINR that the data about UE52 has. In practice, the predetermined condition will be related to the Modulation and Coding Scheme (MCS); the higher the MCS, the greater the “much higher” in the predetermined condition. For example, as the MCS is higher, the predetermined condition may be that the data about the UE532 has at least one of the power, the SNR and the SINR 10 dB higher than the at least one of the power, the SNR and the SINR that the data about UE52 has. It should be noted that “10 dB” is just an example, which may also be other values.

When the result of the sorting does not satisfy the predetermined condition described above, the UE53 performs an operation of interference removal. For example, when the result of the sorting is that at least one of the power, the SNR, and the SINR that the data about the UE532 has is lower or slightly higher than at least one of the power, the SNR, and the SINR that the data about the UE52 has, the UE53 may perform the interference removal operation as follows: according to the step S320 illustrated in FIG. 3, the data stream s₃₂′ is first input into a decoder for the UE52 to decode a data stream including the data about the UE52, and at this time, the data stream also includes data about the UE532 not being decoded. Then, a reconstruction and removal operation of the data of the UE52 is performed on the data stream of the data about the UE52 to obtain a data stream including only the data of the UE532. Finally, the data stream including only the data about the UE532 is input into a decoder for the UE532 to obtain the decoded data stream including only the data about the UE532, and thus the estimated signal data x₃₂′ for the UE532 is obtained.

When the result of the sorting satisfies the predetermined conditions described above, the UE53 may choose whether to perform or not to perform the operation of interference removal according to the equipment performance of the UE53 itself. Specifically, the UE53 may perform the following operation: according to step S320 shown in FIG. 3, a data stream s₃₂′ is first input into a decoder for the UE532 to decode a data stream including the data about the UE532, and at this time, the data stream also includes the data about the UE52 not being decoded. The UE53 may then determine whether to perform the interference removal operation based on its own processing capability, wherein the processing capability of the UE53 may include a device performance of the UE, such as a CPU performance, a motherboard performance, or the like. When the processing capability of the UE53 is weak, the signal data x₃₂′ estimated for the UE532 may be obtained directly without applying interference removal (i.e., Option 1 illustrated in FIG. 6D) to the data stream including the data about the UE532. When the processing capability of the UE53 is strong, the interference removal may be applied to the data stream including the data about the UE532 (i.e., option 2 illustrated in FIG. 6D), specifically, a reconstruction and removal operation of the data about the UE532 is performed on the data stream of the data about the UE532, and at this time, the data stream also includes the data about the UE52 not being decoded, to obtain a data stream that only includes the data of the UE52; then the data stream that includes only the data of the UE52 is input into a decoder for the UE52 to obtain a decoded data stream that includes only the data of the UE52; next, based on the data stream of the data about the UE532 and the decoded data stream that includes only the data of the UE52, the reconstruction and removal operation of the data of UE52 is performed to obtain a data stream that includes only the data about the UE532; and finally, the data stream including only the data about the UE532 is input into a decoder for the UE532 to obtain the decoded data stream including only the data about the UE532, and thus the estimated signal data x₃₂′ for the UE532 is obtained.

Finally, the estimated signal data x₃₁′ for the UE531 and the estimated signal data x₃₂′ for the UE532 may be processed in a way of multilayer data combination according to the step S330 shown in FIG. 3 to obtain the estimated signal data x₃′ for the UE53. Thereby, efficient communication between the UE53 and the network side device with interference removal is realized.

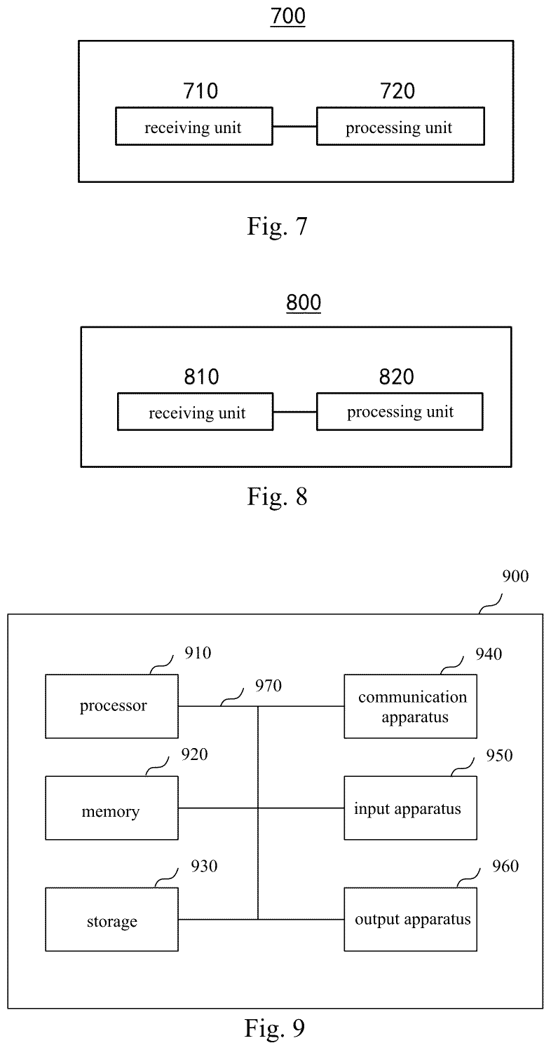

The methods provided by the present disclosure performed by a network side device and a user equipment in a wireless communication network are described above in connection with FIG. 2-FIG. 6D, and the network side device and the user equipment in a wireless communication network provided by the present disclosure will be described below in connection with FIGS. 7 and 8. Since the network side device 700 shown in FIG. 7 and the first user equipment 800 shown in FIG. 8 correspond to the method performed by the network side device and the method performed by the user equipment in the wireless communication network described above in conjunction with FIG. 2-FIG. 6D respectively, a detailed description of the same is omitted herein for the sake of simplicity.

FIG. 7 illustrates a block diagram of a network side device 700 in a wireless communication pathway according to an embodiment of the present disclosure. FIG. 8 illustrates a block diagram of a first user equipment 800 in a wireless communication pathway according to embodiments of the present disclosure.

Referring to FIG. 7, the network side device 700 may include a receiving unit 710 and a processing unit 720. Although in this example, it is illustrated that the network side device 700 includes the receiving unit 710 and the processing unit 720, it should be appreciated that the network side device 700 may also include other components, whose illustrations and descriptions, however, are omitted herein since they are not relevant to the contents of the presently disclosed embodiments.

According to embodiments of the present disclosure, the receiving unit 710 may be configured to receive information about the first user equipment. According to one embodiment of the present disclosure, the network side device may determine a type of the first user equipment based on the information about the first user equipment. The type of user equipment may include a first type and a second type, and the type of user equipment may be indicative of the interference being large or small at the user equipment, wherein the interference being large may include at least one of a Signal-to-Noise Ratio (SNR) and a Signal to Interference plus Noise Ratio (SINR) being small, and the interference being small may include at least one of the SNR and the SINR being large. The type of user equipment may include a first type indicative of a large interference at the user equipment and a second type indicative of a small interference at the user equipment. As an example, the user equipment subject to a large interference may be a user equipment at the edge of the cell, and the user equipment subject to a small interference may be a user equipment at the center of the cell. For example, in the example shown in FIG. 1B, the UE1, the UE3, or the UE4 is a user equipment at the center of the cell, i.e., the UE1, the UE3, or the UE4 is a second type of user equipment; and the UE2 is a user equipment at the edge of the cell, i.e., the UE2 is a first type of user equipment.

According to one embodiment of the present disclosure, the information about the first user equipment may include information about a location of the first user equipment. The network side device may determine that the first user equipment is a first type of user equipment or a second type of user equipment based on the information about the location of the first user equipment. According to another embodiment of the present disclosure, the information about the first user equipment may include information about at least one of a channel state, a receiving power, a signal-to-noise ratio, and a signal-to-interference plus noise ratio. The network side device may determine a channel state of the first user equipment based on the information about at least one of the channel state, the receiving power, the signal-to-noise ratio, and the signal to interference plus noise ratio, thereby determining that the first user equipment is a first type of user equipment or a second type of user equipment.

Furthermore, according to one embodiment of the present disclosure, the first user equipment may measure at least one of its location and channel state, and include the measurement result in information about the first user equipment, which is fed back to the network side device via an uplink control information (UCI) signaling, a Radio Resource Control (RRC) signaling, or a Medium Access Control (MAC) Control Element (CE) signaling, etc., so that the network side device can determine whether the first user equipment is the first type of user equipment or the second type of user equipment.

Alternatively, the network side device may, e.g., via the uplink RS, measure at least one of the location and the channel state of the first user equipment to determine whether the first user equipment is a user equipment at the center of the cell or a user equipment at the edge of the cell.

According to embodiments of the present disclosure, the processing unit 720 may be configured to, when the first user equipment is determined to be a first type of user equipment based on the information about the first user equipment, perform a multi-layer coding (MLC) on the data for the first user equipment to obtain a first data stream and a second data stream about the first user equipment. For example, the first type of user equipment may be the UE2 shown in FIG. 1B. Then, the Non-Orthogonal Multiple-access (NOMA) processing is performed for the first data stream of the first user equipment and the data for the second user equipment to obtain the first preprocessed data, wherein the second user equipment may be the UE1 shown in FIG. 1B. The NOMA processing is performed for the second data stream of the first user equipment and the data for the third user equipment to obtain the second preprocessed data, wherein the third user equipment may be at least one of the UE3 and the UE4 illustrated in FIG. 1B, and wherein the intra-beam interference may be removed by the above-described NOMA processing. The first preprocessed data and the second preprocessed data are separately pre-coded respectively. By pre-coding the first preprocessed data and the second preprocessed data separately, the SDMA processing may be performed for the first preprocessed data and the second preprocessed data to be transmitted, wherein the inter-beam interference may be removed by the above-described SDMA processing. For example, the pre-coding may be performed for the first preprocessed data and the second preprocessed data respectively, so as to obtain a first to-be-transmitted data to be transmitted using the first beam and a second to-be-transmitted data to be transmitted using the second beam, and then the first to-be-transmitted data and the second to-be-transmitted data may be transmitted using the MIMO so as to cover signals to all of the UEs within the corresponding communication coverage area.

In addition, in order to make it easier for the user equipment to decode the received signals, the network side device may assign different powers for the data about different user equipments, such as assigning a high power for the data about the second type of user equipment and a low power for the data about the first type of user equipment, and vice versa. Alternatively, different multiple-access signatures, such as spread spectrum sequences, scrambled sequences, interleaved sequences, or the like, may be assigned to the data about different user equipments.

As can be seen from the above network side device provided by the present disclosure above, the above network side device provided by the present disclosure effectively removes the interference of the first type of user equipment and the second type of user equipment while simultaneously taking into account both inter-beam and intra-beam interference, and thus improves the overall system efficiency of the wireless communication network, so as to simultaneously and efficiently provide services to at least three users.

The above description is provided for the case in which the first user equipment is a first type of user equipment. According to another example of the present disclosure, the processing unit 720 may be configured to, when the first user equipment is not the first type of user equipment but is the second type of user equipment, a NOMA process may be performed for the data for the first user equipment and the data for the second user equipment to obtain a third preprocessed data, e.g., the first user equipment may be the UE3 shown in FIG. 1B, and the second user equipment may be the UE4 shown in FIG. 1B, and the intra-beam interference may be removed by the NOMA processing described above. Then, the third preprocessed data and the data for the third user equipment are pre-coded separately, for example, the third user equipment may be UE1 shown in FIG. 1B. By pre-coding the third preprocessed data and the data for the third user equipment separately, the SDMA processing may be performed for the third preprocessed data and the data for the third user equipment to be transmitted, wherein inter-beam interference can be removed by the above-described SDMA processing. For example, the third preprocessed data and the data for the third user equipment may be pre-coded to obtain the third to-be-transmitted data to be transmitted using the third beam and the fourth to-be-transmitted data to be transmitted using the fourth beam, and the third to-be-transmitted data and the fourth to-be-transmitted data may be transmitted utilizing MIMO to cover the signal to all of the UEs within the corresponding communication coverage area.

In addition, in order to make it easier for the user equipments to decode the received signals, the network side device may assign different powers for the data about different user equipments, such as assigning a high power for the data about the second type of user equipment and a low power for the data about the first type of user equipment, and vice versa. Alternatively, different multiple-access signatures, such as spread spectrum sequences, scrambled sequences, interleaved sequences, or the like, may be assigned to the data about different user equipments.

As can be seen from the above network side device provided by the present disclosure, the above network side device provided by the present disclosure does not require separate signal processing methods to be designed for different scenarios, and the same method can be used for different types of user equipments under all the scenarios respectively. This effectively removes interference of the first type of user equipment and the second type of user equipment when both inter-beam and intra-beam interference are considered, thereby enhancing the overall system efficiency of the wireless communication network, and making it possible to provide services to at least three users simultaneously and efficiently.

Referring to FIG. 8, the first user equipment 800 may include a receiving unit 810 and a processing unit 820. Although in this example, it is shown that the network side device 800 includes the receiving unit 810 and the processing unit 820, it should be appreciated that the network side device 800 may also include other components, whose illustrations and descriptions, however, are omitted herein since they are not relevant to the contents of the presently disclosed embodiments.

According to embodiments of the present disclosure, the receiving unit 810 may be configured to receive user data from a network side device, such as receiving a signal transmitted by the network side device utilizing the MIMO.

According to embodiments of the present disclosure, the processing unit 820 may be configured to, when the user data includes more than one data stream about the first user equipment, process each data stream to obtain user data about the first user equipment, wherein each data stream includes data about the first user equipment and data about the other user equipment, and to combine the user data about the first user equipment that is obtained by processing each data stream.

According to an example of the present disclosure, the user data may include two data streams about the first user equipment, indicating that the first user equipment is a first type of user equipment at this time. For example, the user data may include two data streams including a data stream including the first preprocessed data and a data stream including the second preprocessed data with respect to the UE2 as illustrated in FIG. 1B, and the UE2 is being served by both the beams 110 and 120.

According to an example of the present disclosure, the processing unit 820 may process each of the two data streams to obtain user data about the first user equipment. For example, interference removal may be performed for each data stream. This has been further described above in connection with FIG. 6D. The processing unit 820 then combines the user data about the first user equipment obtained by processing each of the above two data streams. For example, the above combination is carried out by way of performing a combination of multiple layers of data to obtain estimated signal data for the first user equipment.

From the above described first user equipment according to an embodiment of the present disclosure in conjunction with FIG. 8, it can be seen that the first user equipment can be well served by the two beams, and the effects of inter-beam interference and intra-beam interference are effectively removed.

According to embodiments of the present disclosure, the processing unit 820 is configured to process the data stream to obtain user data about the first user equipment when the user data includes only one data stream about the first user equipment, wherein the data stream includes data about the first user equipment and data about another user equipment.

As an example, the first user equipment may be the UE1, UE3, or UE4 shown in FIG. 1B. The other user equipment may be the UE2 shown in FIG. 1B.

As an example, when the user data includes only one data stream about the first user equipment, it is indicated that the first user equipment is a second type of user equipment at that time.

As an example, the one data stream described above may include a data stream of the first preprocessed data described above or a data stream of the second preprocessed data described above.

According to embodiments of the present disclosure, the first user equipment may further include a transmitting unit (not shown), which may be configured to transmit information about the first user equipment to a network side device in a wireless communication network to cause the network side device to determine a type of the first user equipment based on the information about the first user equipment.

As can be seen from the first user equipment described above in conjunction with FIG. 8, the user equipment provided by the present disclosure takes into account both inter-beam and intra-beam interference, effectively removes interference of the first type of user equipment and the second type of user equipment, and improves the overall system efficiency of the wireless communication network.

### <Hardware Structure>

In addition, block diagrams used in the description of the above embodiments illustrate blocks in units of functions. These functional blocks (structural units) may be implemented in arbitrary combination of at least one of hardware and software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. wired and/or wirelessly), and the respective functional blocks may be implemented by these apparatuses.

For example, the electric device in one embodiment of the present disclosure may function as a computing device that executes the processes of the wireless communication method of the present disclosure.

FIG. 9 is a schematic diagram of a hardware structure of a device 900 (an electric device) according to an embodiment of the present disclosure, wherein the device 900 can both be the above network side device and the above user equipment (such as the above first user equipment, the second user equipment, the third equipment or the like).

The above device 900 (the first network element) may be constituted as a computer apparatus that physically includes a processor 910, a memory 920, a storage 930, a communication apparatus 940, an input apparatus 950, an output apparatus 960, a bus 970 or the like

In addition, in the following description, terms such as “apparatus” may be replaced with circuits, devices, units, or the like. The hardware structure of the electric device may include one or more of the respective apparatuses shown in the figure, or may not include a part of the apparatuses.

For example, only one processor 910 is illustrated, but there may be multiple processors. Furthermore, processes may be performed by one processor, or processes may be performed by more than one processor simultaneously, sequentially, or with other methods. In addition, the processor 910 may be installed by more than one chip.

Respective functions of any of the device 900 may be implemented, for example, by reading specified software (program) on hardware such as the processor 910 and the memory 920, so that the processor 910 performs computations, controls communication performed by the communication apparatus 940, and controls reading and/or writing of data in the memory 920 and the storage 330.

The processor 910, for example, operates an operating system to control the entire computer. The processor 910 may be constituted by a Central Processing Unit (CPU), which includes interfaces with peripheral apparatuses, a control apparatus, a computing apparatus, a register or the like. For example, the processing unit described above may be implemented by the processor 910.

In addition, the processor 910 reads programs (program codes), software modules and data or the like from the storage 930 and/or the communication apparatus 940 to the memory 920, and execute various processes according to them. As for the program, a program causing computers to execute at least a part of the operations described in the above embodiments may be employed. For example, the processing unit of the first network element may be implemented by a control program stored in the memory 920 and operated by the processor 910, and other functional blocks may also be implemented similarly.

The memory 920 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 920 may also be referred to as a register, a cache, a main memory (a main storage apparatus) or the like. The memory 920 may store executable programs (program codes), software modules or the like for implementing a method involved in an embodiment of the present disclosure.

The storage 930 is a computer-readable recording medium, and may be constituted, for example, by at least one of a flexible disk, a Floppy® disk, a magneto-optical disk (e.g., a Compact Disc ROM (CD-ROM) or the like, a digital versatile disk, a Blu-ray® disk), a removable disk, a hard driver, a smart card, a flash memory device (e.g., a card, a stick and a key driver), a magnetic stripe, a database, a server, and other appropriate storage media. The storage 930 may also be referred to as an auxiliary storage apparatus.

The communication apparatus 940 is a hardware (transceiver device) performing communication between computers via at least one of a wired network and a wireless network, and is also referred to as a network device, a network controller, a network card, a communication module or the like, for example. The communication apparatus 940 may include a high-frequency switch, a duplexer, a filter, a frequency synthesizer or the like to implement, for example, Frequency Division Duplex (FDD) and/or Time Division Duplex (TDD). For example, the transmitting unit, the receiving unit or the like described above may be implemented by the communication apparatus 940.

The input apparatus 950 is an input device (e.g., a keyboard, a mouse, a microphone, a switch, a button, a sensor or the like) that receives input from the outside. The output apparatus 960 is an output device (e.g., a display, a speaker, a Light Emitting Diode (LED) light or the like) that performs outputting to the outside. In addition, the input apparatus 950 and the output apparatus 960 may also be an integrated structure (e.g., a touch screen).

Furthermore, the respective apparatuses such as the processor 910 and the memory 920 are connected by the bus 970 that communicates information. The bus 970 may be constituted by a single bus or by different buses between the apparatuses.

Furthermore, the electronic device may include hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 910 may be installed by at least one of these hardware.

The present disclosure also provides a computer-readable storage medium having stored thereon computer instructions that, when executed by a processor, enable the method of wireless communication at a network side device or a first user equipment as described above. Similarly, the computer-readable storage medium in embodiments of the present disclosure may be volatile memory or non-volatile memory, or may include both volatile and non-volatile memory. It should be noted that the computer-readable storage media described herein are intended to include, but are not limited to, these and any other suitable types of memory.

It should be noted that the functionality and arrangement of the elements discussed may be varied without departing from the scope of the present disclosure. Various examples may omit, substitute, or add various processes or components as appropriate. For example, the described methods may be performed in a different order than that described, and various steps may be added, omitted, or combined. Moreover, features described with respect to some examples may be combined in some other examples. For example, any number of aspects set forth herein may be used to implement devices or practice methods. Moreover, the scope of the present disclosure is intended to cover such devices or methods practiced using other structures, features, or structures and features other than or in addition to the aspects of the present disclosure set forth herein.

In addition, the flowcharts and block diagrams in the accompanying drawings illustrate the architecture, functionality, and operation of systems, methods, and computer program products that may be implemented in accordance with various embodiments of the present disclosure. At this point, each box in the flowcharts or block diagrams may represent a module, program segment, or portion of code that contains one or more executable instructions for implementing a specified logical function. It should also be noted that in some implementations as replacements, the functions labeled in the boxes may also occur in a different order than those labeled in the accompanying drawings. For example, two consecutively represented boxes may actually be executed substantially in parallel, and they may sometimes be executed in reverse order, depending on the function involved. It should also be noted that each box in a block diagram or flowchart, and combinations of boxes in a block diagram or flowchart, may be implemented with a specialized hardware-based system that performs the specified function or operation, or may be implemented with a combination of specialized hardware and computer instructions.

In general, various example embodiments of the present disclosure may be implemented in hardware or specialized circuitry, software, firmware, logic, or any combination thereof. Certain aspects may be implemented in hardware, while other aspects may be implemented in firmware or software that may be executed by a controller, microprocessor, or other computing device. When aspects of embodiments of the present disclosure are illustrated or described as block diagrams, flowcharts, or using certain other graphical representations, it will be understood that the boxes, devices, systems, techniques, or methods described herein may be implemented in hardware, software, firmware, specialized circuitry or logic, general-purpose hardware, or controllers, or other computing devices, or in certain combinations thereof, as non-limiting examples.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple-access (CDMA), time division multiple-access (TDMA), frequency division multiple-access (FDMA), orthogonal frequency division multiple-access (OFDMA), single carrier frequency division multiple-access (SC-FDMA), and other systems. A CDMA system may implement a radio technology such as CDMA2000, Universal Terrestrial Radio Access (UTRA), etc. CDMVA2000 covers IS-2000, IS-95, and IS-856 standards. IS-2000 Releases may be commonly referred to as CDMVA2000 1×, 1×, etc. IS-856 (TIA-856) is commonly referred to as CDMVA2000 1×EV-DO, High-Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

The wireless communication systems described herein may support either synchronous or asynchronous operation. For synchronous operation, base stations may have similar frame timings and transmissions from different base stations may be approximately calibrated in time. For asynchronous operation, the base stations may have different frame timings and transmissions from different base stations may be uncalibrated in time. The techniques described herein may be used for synchronous or asynchronous operation.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The terms “beam” and “cell” as used herein may be used interchangeably.

The various illustrative blocks and modules described in connection with the disclosure herein may be implemented or performed with a general-purpose processor, a digital signal processor (DSP), an ASIC, a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples”. The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A network side device in a wireless communication network, comprising:
a receiving unit configured to receive information about a first user equipment;
a processing unit configured to, when the first user equipment is determined to be a first type of user equipment based on the information about the first user equipment, multi-layer code data for the first user equipment to obtain a first data stream and a second data stream about the first user equipment, perform a non-orthogonal multiple-access processing of the first data stream and the second data stream of the first user equipment with data for a second user equipment and data for a third user equipment respectively to obtain a first preprocessed data and a second preprocessed data, and pre-coding the first preprocessed data and the second preprocessed data respectively, wherein the second user equipment and the third user equipment are a second type of user equipment.

2. The network side device as claimed in claim 1, wherein
the information about the first user equipment comprises information about at least one of
a location, a channel state, a power, a signal-to-noise ratio, and a signal to interference plus noise ratio of the first user equipment.

3. The network side device as claimed in claim 1, wherein
the processing unit pre-codes the first preprocessed data and the second preprocessed data
respectively to obtain a first to-be-transmitted data to be transmitted using a first beam and a second to-be-transmitted data to be transmitted using a second beam.

4. The network side device as claimed in claim 1, wherein
the first type of user equipment is a user equipment located at an edge of a cell, and
the second type of the user equipment is a user equipment located at a center of the cell.

5. The network side device as claimed in claim 1, wherein
the processing unit is further configured to, when the first user equipment is determined to be the second type of user equipment based on the information about the first user equipment, perform non-orthogonal multiple-access processing of the data for the first user equipment with the data for the second user equipment to obtain a third preprocessed data, and pre-code the third preprocessed data and the data for the third user equipment respectively, wherein the second user equipment and the third user equipment are the second type of user equipment.

6. The network side device as claimed in claim 1, wherein
the network side device is at least one of a high altitude platform station, a near-orbit satellite, or a terrestrial base station.

7. A first user equipment in a wireless communication network, comprising:
a receiving unit configured to receive user data from a network side device;
a processing unit configured to, when the user data comprises more than one data stream about the first user equipment, process each data stream to obtain user data about the first user equipment, wherein each data stream comprises data about the first user equipment and data about another user equipment, and combine the user data about the first user equipment obtained by processing the each data stream.

8. The first user equipment as claimed in claim 7, further comprising:
a transmitting unit configured to transmit information about the first user equipment to the network side device in the wireless communication network to cause the network side device to determine a type of the first user equipment based on the information about the first user equipment.

9. A method for wireless communication at a network side device, comprising:
receiving information about a first user equipment;
when the first user equipment is determined to be a first type of user equipment based on the information about the first user equipment, multi-layer coding data for the first user equipment to obtain a first data stream and a second data stream about the first user equipment, performing a non-orthogonal multiple-access processing of the first data stream and the second data stream of the first user equipment with data for a second user equipment and data for a third user equipment respectively to obtain a first preprocessed data and a second preprocessed data, and pre-coding the first preprocessed data and second preprocessed data respectively, wherein the second user equipment and the third user equipment are a second type of user equipment.

10. A method as claimed in claim 9, wherein
pre-coding the first preprocessed data and the second preprocessed data respectively to obtain a first to-be-transmitted data to be transmitted using a first beam and a second to-be-transmitted data to be transmitted using a second beam.
